(19) United States
(12) Patent Application Publication
(10) Pub. No.: US 2019/0200008 A1
(43) Pub. Date: Jun. 27, 2019

(54) METHOD AND DEVICE FOR TESTING SCREEN FLUENCY OF TERMINAL, AND TERMINAL DEVICE

(71) Applicant: ZHUHAI JUNTIAN ELECTRONIC TECHNOLOGY CO., LTD., Guangdong (CN)

(72) Inventor: Chao Wang, Beijing (CN)

(73) Assignee: ZHUHAI JUNTIAN ELECTRONIC TECHNOLOGY CO., LTD., Guangdong (CN)

(21) Appl. No.: 16/002,633

(22) Filed: Jun. 7, 2018

(30) Foreign Application Priority Data
Dec. 22, 2017 (CN) 201711407680.9

(51) Int. Cl. H04N 17/00

(52) U.S. Cl. CPC H04N 17/00

(57) ABSTRACT

The present disclosure provides a method, a device for testing a screen fluency of a terminal, and a terminal device. The method includes: in response to receiving a test instruction, obtaining attribute information of a terminal and a test case, in which the attribute information including a screen refresh rate; controlling the test case to be displayed in the terminal according to a preset rule to obtain a number of frames generated by the terminal and a time period taken by the terminal to generate the frames; determining the screen fluency of the terminal based on the screen refresh rate, the number of frames and the time period.

### CROSS REFERENCE TO RELATED APPLICATION

This application is based on and claims priority of Chinese Patent Application No. 201711407680.9, filed on Dec. 22, 2017, the entire contents of which are incorporated herein by reference.

### FIELD

The present disclosure relates to an electronic technology field, and more particularly to a method and a device for testing a screen fluency of a terminal, and a terminal device.

### BACKGROUND

Nowadays, various terminal devices have a touch screen. A user can perform various operations, such as browsing news, playing videos, and the like, on a terminal device via the touch screen. Therefore, fluency of a terminal screen may directly affect user acceptance of the terminal.

### SUMMARY

Embodiments of the present disclosure provide a method for testing a screen fluency of a terminal, including: in response to receiving a test instruction, obtaining attribute information of the terminal and a test case, in which the attribute information includes a screen refresh rate; controlling the test case to be displayed in the terminal according to a preset rule to obtain a number of frames generated by the terminal and a time period taken by the terminal to generate the frames; and determining the screen fluency of the terminal based on the screen refresh rate, the number of frames and the time period.

Embodiments of the present disclosure provide a device for testing a screen fluency of a terminal, including: a first obtaining module, configured to obtain attribute information of the terminal and a test case in response to receiving a test instruction, in which the attribute information includes a screen refresh rate; a second obtaining module, configured to control the test case to be displayed in the terminal according to a preset rule to obtain a number of frames generated by the terminal and a time period taken by the terminal to generate the frames; and a determining module, configured to determine the screen fluency of the terminal based on the screen refresh rate, the number of frames and the time period.

Embodiments of the present disclosure provide a terminal device, including: a memory, a processor and a touch screen. The memory is configured to store an executable program code; the touch screen is configured to display a test case; the processor is configured to read the executable program code stored in the memory to execute a program corresponding to the executable program code, to implement a method for testing a screen fluency of a terminal according to above embodiments.

Embodiments of the present disclosure provide a non-transitory computer-readable storage medium, having a computer program stored thereon, when executed by a processor, the computer program is caused to implement a method for testing a screen fluency of a terminal according to above embodiments.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a method for testing a screen fluency of a terminal according to an embodiment of the present disclosure.

FIG. 2 is a flow chart of a method for testing a screen fluency of a terminal according to another embodiment of the present disclosure.

FIG. 3 is a block diagram for illustrating a device for testing a screen fluency of a terminal according to an embodiment of the present disclosure.

FIG. 4 is schematic diagram for illustrating a terminal device according to an embodiment of the present disclosure.

### DETAILED DESCRIPTION

Reference will be made in detail to embodiments of the present disclosure. Examples of the embodiments are shown in the drawings. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the related art, a person may generally operate the touch screen, such as performing a sliding operation on the touch screen, and then the person may give user subjective evaluation of screen fluency. In this testing way, when testing fluency of a same terminal screen, there may be a great gap between conclusions about the fluency given by different persons. This testing way has a high dependency on person, a high testing cost, and accuracy and reliability of test result may be low.

Aiming to solve a problem of dependency on manual test, high testing cost and low accuracy and reliability of test result in the related art, embodiments of the present disclosure provide a method for testing a screen fluency of a terminal.

With the method for testing a screen fluency of a terminal provided in embodiments of the present disclosure, in response to receiving the test instruction, the attribute information of the terminal and the test case are obtained, the test case is controlled to be displayed in the terminal according to the preset rule to obtain the number of frames generated by the terminal and the time period taken by the terminal to generate the frames, and the screen fluency of the terminal is determined based on the screen refresh rate, the number of frames and the time period taken by the terminal to generate the frames. Thus it realizes an automatic test of the screen fluency of the terminal according to the attribute information of the terminal and the test case, and not only the accuracy and reliability for testing the screen fluency of the terminal are improved, but also cost of manual testing is reduced, improving speed and efficiency of testing the screen fluency of the terminal, and improving user experience.

In the following, a method for testing a screen fluency of a terminal provided in embodiments of the present disclosure will be described in detail with reference to drawings.

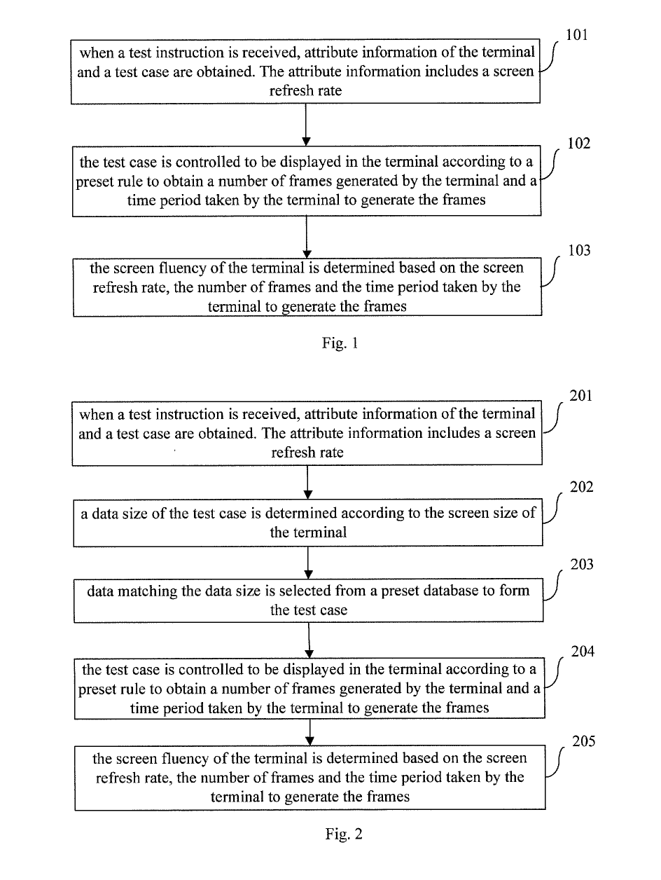

FIG. 1 is a flow chart of a method for testing a screen fluency of a terminal according to an embodiment of the present disclosure.

As illustrated in FIG. 1, the method for testing a screen fluency of a terminal may include follows.

At block 101, when a test instruction is received, attribute information of the terminal and a test case are obtained. The attribute information includes a screen refresh rate.

In detail, the method for testing a screen fluency of a terminal may be implemented by a device for testing a screen fluency of a terminal provided in embodiments of the present disclosure. The device may be configured in any terminal to realize controlling the test of screen fluency of a terminal.

In this embodiment, the terminal may be any hardware device having a touch screen, for example, a smart phone, a personal digital assistant, a tablet computer, a electronic reader, and the like, which is not limited herein.

In this embodiment, the screen refresh rate refers to a number of times a frame in the screen of the terminal being refreshed per second, for example, 60 times refreshed per second, etc.

In detail implementation, when the test instruction is received, a device for testing a screen fluency of a terminal may obtain the test case from a memory unit according to the test instruction. In this embodiment, the obtained test case may be obtained from a local memory unit, or from a server, which is not limited in this embodiment. The test case may be a picture, a list, or the like.

After the device for testing a screen fluency of a terminal receives the test instruction, the device may obtain the screen refresh rate of the terminal by calling a system function in the terminal. For example, if android system is installed in a terminal where the device is located, the screen refresh rate of the terminal may be obtained by calling function WindowManager.getDefaultDisplay..getRefreshRate( ).

At block 102, the test case is controlled to be displayed in the terminal according to a preset rule to obtain a number of frames generated by the terminal and a time period taken by the terminal to generate the frames.

In embodiments of the present disclosure, the preset rule may be adaptively set according actual application. For example, the test case may be displayed in a way of upward sliding in turn, or in a way of first upward sliding and then downward sliding, or in a way of first sliding to left and then sliding to right, or the like, which is not limited herein.

For example, the preset rule is that the test case is to be displayed in a way of first upward sliding and then downward sliding. The device for testing a screen fluency of a terminal may simulate a user performing an operation sliding from top to down and an operation sliding from bottom to up on the test case in turn, to control data in the test case to be displayed in an order first from top to down and then from bottom to up in turn.

It should be noted that, speeds of respective user sliding the screen of the terminal are different in actual application, therefore, the preset rule in this embodiment may further include a sliding speed, thus a sliding speed of the test case may be controlled based on the preset sliding speed included in the preset rule when the test case is displayed.

In detail, when the test case is displayed in the terminal according to a preset rule, the device for testing a screen fluency of a terminal may determine the number of frames generated by the terminal to generate the frames according to a number of callbacks of a frame monitoring function in the terminal, and may determine the time period taken by the terminal according to time of callbacks of a frame monitoring function in the terminal.

In detail implementation, the device for testing a screen fluency of a terminal may configure the frame monitoring function in the terminal used for monitoring frames generated by the terminal. For example, for a terminal with an android system, a frame monitor may be first configured by calling a function Choreographer.getInstance( ).postFrameCallback( ). When the terminal generates frames, i.e., when the frame monitoring function is called, the above monitor may return a valid value to the device for testing a screen fluency of a terminal, thus the number of frames generated by the terminal is added to one by the device for testing a screen fluency of a terminal. In addition, the time period taken by the terminal to generate the frames when the test case is displayed in the terminal is determined based on a time point when a value returned from the monitor is obtained for the first time and a time point when a value returned from the monitor is obtained for the last time.

Further, in detail implementation of the present disclosure, the time period taken by the terminal to generate the frames when the test case is displayed may be obtained via a timer. In detail, the timer may record a start time T1 when the test case begins to be displayed in the terminal according to the preset rule, and the timer may record a finish time T2 when displaying the test case in the terminal is finished. Then the time period taken by the terminal for displaying the test case may the determined according to a difference between the start time T1 and the finish time T2.

At block 103, the screen fluency of the terminal is determined based on the screen refresh rate, the number of frames and the time period taken by the terminal to generate the frames.

In this embodiment, after the number of frames generated by the terminal and the time period taken by the terminal to generate the frames are obtained, the screen fluency of the terminal is determined based on the screen refresh rate, the number of frames and the time period taken by the terminal to generate the frames.

In detail implementation, a frame rate of the terminal may be firstly determined based on the number of frames and the time period taken by the terminal to generate the frames, and then the screen fluency of the terminal is determined based on the frame rate and the screen refresh rate.

The frame rate, generally call as FPS, is a measurement for measuring a number of displayed frames, illustrating a number of refresh times of a picture per second. That is, a higher frame rate may result in a more fluent and more realistic animation. On the contrary, the screen may appear to be stuck, thus affecting user experience.

For example, the number of frames is 60, the time period taken by the terminal to generate the frames is 2 seconds. An average frame rate of the terminal is calculated to be 30 fps according to a formula (1):

$$\frac{F}{T} = AFPS .$$

F is the number of frames, T is the time period taken by the terminal to generate the frames, AFPS is the average frame rate.

Further, if the obtained screen refresh rate of the terminal is 60 Hertz (Hz), the screen fluency of the terminal is calculated to be 0.5 according to formula (2):

$$\frac{AFPS}{S} = f .$$

AFPS is the average frame rate, S is the screen refresh rate, f is the screen fluency of the terminal. That is, the terminal displays one picture on the screen each two times.

It should be noted that, in this embodiment, the screen fluency of a terminal is tested by obtaining the number of frames generated by the terminal, and the time period taken by the terminal to generate the frames via the device for testing a screen fluency of a terminal, thus eliminating a need for manual participation, saving testing cost, improving the accuracy and reliability of testing, and improving user experience.

With the method for testing a screen fluency of a terminal provided in embodiments of the present disclosure, in response to receiving the test instruction, the attribute information of the terminal and the test case are obtained, the test case is controlled to be displayed in the terminal according to the preset rule to obtain the number of frames generated by the terminal and the time period taken by the terminal to generate the frames, and the screen fluency of the terminal is determined based on the screen refresh rate, the number of frames and the time period taken by the terminal to generate the frames. Thus it realizes an automatic test of the screen fluency of the terminal according to the attribute information of the terminal and the test case, and not only the accuracy and reliability for testing the screen fluency of the terminal are improved, but also cost of manual testing is reduced, improving speed and efficiency of testing the screen fluency of the terminal, and improving user experience.

It can be known from above analysis that, in embodiments of the present disclosure, the screen fluency of a terminal is tested based on the screen refresh rate, the number of frames and the time period taken by the terminal to generate the frames. In detail implementation, display screen size varies with different terminals, therefore, data size of the test case displayed by the terminal screen each time varies. Thus, there may be great difference between test time of different terminals if a same test case is used to test terminals with different display screen sizes. Therefore, to make the process of testing a screen fluency of various terminals accurate, and to not waste user's time, in this embodiment, a test case matching a screen size of the terminal is obtained, thus the test effect of the screen fluency of the terminal is better. In the following, a method for testing a screen fluency of a terminal under above situation is further described in combination with FIG. 2.

FIG. 2 is a flow chart of a method for testing a screen fluency of a terminal according to another embodiment of the present disclosure.

As illustrated in FIG. 2, the method for testing a screen fluency of a terminal may include followings.

At block 201, when a test instruction is received, attribute information of the terminal and a test case are obtained. The attribute information includes a screen refresh rate and a screen size.

The screen size may include a length and a width of a screen.

In detail implementation, the device for testing a screen fluency of a terminal may obtain the screen size information according to a system of the terminal by calling different system function. For example, for the android system let Dimensions=require(‘Dimensions’) may be called, etc., which is not limited in embodiments of the present disclosure.

At block 202, a data size of the test case is determined according to the screen size of the terminal.

At block 203, data matching the data size is selected from a preset database to form the test case.

The preset database may be established according to data locally stored in the terminal, or may be established according to data obtained from a server, which is not limited in embodiments of the present disclosure.

In detail, display screen size varies with different terminals, therefore, if a preset numbers of test cases are obtained for testing a screen fluency of a terminal, the screen size may not match the data size of the test cases. For example, the data in the test cases may be too little, it may result in the final testing result may not accurate, or if the data in the test cases may be too much, it may make the test process too long.

Therefore, to avoid above problem, in this embodiment, in response to receiving the test instruction, the device for testing a screen fluency of a terminal may obtain the screen size of the terminal, and obtain the data size to be displayed matching the screen size. Then the data matching the data size is selected from the preset database to form the test case matching the screen size of the terminal. Thus it can ensure that the obtained data can determine the screen fluency of the terminal as accurate as possible and may not make the test process too long when the test case is displayed in the terminal.

At block 204, the test case is controlled to be displayed in the terminal according to a preset rule to obtain a number of frames generated by the terminal and a time period taken by the terminal to generate the frames.

At block 205, the screen fluency of the terminal is determined based on the screen refresh rate, the number of frames and the time period taken by the terminal to generate the frames.

With the method for testing a screen fluency of a terminal provided in embodiments of the present disclosure, in response to receiving the test instruction, the attribute information of the terminal and the test case are obtained, in which the attribute information includes the screen refresh rate and the screen size of the terminal. Then the data size of the test case is determined according to the screen size of the terminal, the data matching the data size is selected from a preset database to form the test case. Then the test case is controlled to be displayed in the terminal according to the preset rule to obtain the number of frames generated by the terminal and the time period taken by the terminal to generate the frames, and the screen fluency of the terminal is determined based on the screen refresh rate, the number of frames and the time period taken by the terminal to generate the frames. Thereby, it realizes that the corresponding test case is obtained according to the screen size of the terminal when testing the screen fluency of a terminal, thus improving accuracy of the test for screen fluency of a terminal, avoiding the mismatch between the data size of the test case and the screen size of the terminal, which results in a large error in the test result or the test process taking too long time, and further improving user experience.

To achieve the above embodiments, the present disclosure further provides a device for testing a screen fluency of a terminal.

In the following, the device for testing a screen fluency of a terminal provided in embodiments of the present disclosure will be illustrated with reference to drawings.

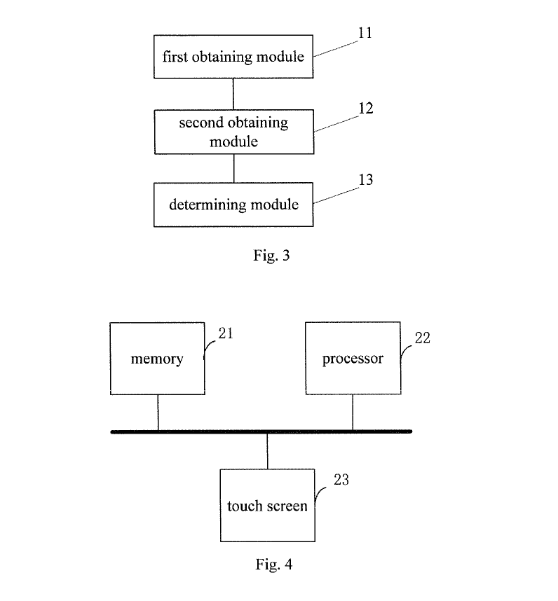

FIG. 3 is a block diagram for illustrating a device for testing a screen fluency of a terminal according to an embodiment of the present disclosure.

As illustrated in FIG. 3, the device for testing a screen fluency of a terminal includes a first obtaining module 11, a second obtaining module 12, and a determining module 13.

The first obtaining module 11 is configured to obtain attribute information of the terminal and a test case in response to receiving a test instruction. The attribute information includes a screen refresh rate.

The second obtaining module 12 is configured to control the test case to be displayed in the terminal according to a preset rule to obtain a number of frames generated by the terminal and a time period taken by the terminal to generate the frames.

The determining module 13 is configured to determine the screen fluency of the terminal based on the screen refresh rate, the number of frames and the time period taken by the terminal to generate the frames.

In another embodiment of the present disclosure, the attribute information further includes a screen size of the terminal. The first obtaining module 11 includes: a first determining unit, configured to determine a data size of the test case according to the screen size of the terminal; a forming unit, configured to select data matching the data size from a preset database to form the test case.

Further, the second obtaining module 12 in the device for testing a screen fluency of a terminal according to embodiments of the present disclosure is configured to: determine the number of frames generated by the terminal according to a number of callbacks of a frame monitoring function in the terminal.

In another embodiment of the present disclosure, the second obtaining module 12 is configured to: control the test case to be displayed in the terminal in a sliding manner based on a preset order and/or speed.

Further, the determining module 13 in this embodiment includes a second determining unit and a third determining unit.

The second determining unit is configured to determine a frame rate of the terminal based on the number of frames and the time period taken by the terminal to generate the frames. A third determining unit is configured to determine the screen fluency of the terminal based on the frame rate and the screen refresh rate.

It should be noted that, the implementation process and technical principle of the device for testing a screen fluency of a terminal according to embodiments of the present disclosure may refer to forgoing the descriptions in foregoing embodiments of the method for testing a screen fluency of a terminal, and it is not described in detail herein.

With the device for testing a screen fluency of a terminal provided in embodiments of the present disclosure, in response to receiving the test instruction, the attribute information of the terminal and the test case are obtained, the test case is controlled to be displayed in the terminal according to the preset rule to obtain the number of frames generated by the terminal and the time period taken by the terminal to generate the frames, and the screen fluency of the terminal is determined based on the screen refresh rate, the number of frames and the time period taken by the terminal to generate the frames. Thus it realizes an automatic test of the screen fluency of the terminal according to the attribute information of the terminal and the test case, and not only the accuracy and reliability for testing the screen fluency of the terminal are improved, but also cost of manual testing is reduced, improving speed and efficiency of testing the screen fluency of the terminal, and improving user experience.

To achieve the above embodiments, the present disclosure further provides a terminal device.

FIG. 4 is schematic diagram for illustrating a terminal device according to an embodiment of the present disclosure.

As illustrated in FIG. 4, the terminal device includes a memory 21, a processor 22 and a touch screen 23.

The memory 21 is configured to store an executable program code.

The touch screen 23 is configured to display a test case.

The processor 22 is configured to read the executable program code stored in the memory 21 to execute a program corresponding to the executable program code, to implement a method for testing a screen fluency of a terminal according to above embodiments.

It should be noted that, the implementation process and technical principle of the terminal device according to embodiments of the present disclosure may refer to forgoing the descriptions in foregoing embodiments of the method for testing a screen fluency of a terminal, and it is not described in detail herein.

With the terminal device provided in embodiments of the present disclosure, in response to receiving the test instruction, the attribute information of the terminal and the test case are obtained, the test case is controlled to be displayed in the terminal according to the preset rule to obtain the number of frames generated by the terminal and the time period taken by the terminal to generate the frames, and the screen fluency of the terminal is determined based on the screen refresh rate, the number of frames and the time period taken by the terminal to generate the frames. Thus it realizes an automatic test of the screen fluency of the terminal according to the attribute information of the terminal and the test case, and not only the accuracy and reliability for testing the screen fluency of the terminal are improved, but also cost of manual testing is reduced, improving speed and efficiency of testing the screen fluency of the terminal, and improving user experience.

To achieve the above embodiments, the present disclosure further provides a non-transitory computer-readable storage medium. The non-transitory computer-readable storage medium has a computer program stored thereon, when executed by a processor, the computer program is caused to implement a method for testing a screen fluency of a terminal according to above embodiments. The method for testing a screen fluency of a terminal includes: in response to receiving a test instruction, obtaining attribute information of the terminal and a test case, in which the attribute information includes a screen refresh rate; controlling the test case to be displayed in the terminal according to a preset rule to obtain a number of frames generated by the terminal and a time period taken by the terminal to generate the frames; and determining the screen fluency of the terminal based on the screen refresh rate, the number of frames and the time period taken by the terminal to generate the frames.

Reference throughout this specification to “one embodiment”, “some embodiments”, “an example”, “a specific example”, or “some examples” means that a particular feature, structure, material, or characteristic described in connection with the embodiment or example is included in at least one embodiment or example of the present disclosure.

In addition, terms such as “first” and “second” are used herein for purposes of description and are not intended to indicate or imply relative importance or significance. Thus, the feature defined with “first” and “second” may comprise one or more of this feature.

Any process or method described in a flow chart or described herein in other ways may be understood to include one or more modules, segments or portions of codes of executable instructions for achieving specific logical functions or steps in the process, and the scope of an embodiment of the present disclosure includes other implementations, in which functions may be not performed in an order that is not shown or discussed, including in a substantially simultaneous manner or in an opposite order according to the functions involved, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It can be understood that all or part of the steps in the method of the above embodiments can be implemented by instructing related hardware via programs, the program may be stored in a computer readable storage medium, and the program includes one step or combinations of the steps of the method when the program is executed.

The above-mentioned storage medium may be a read-only memory, a magnetic disc, an optical disc, etc.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method for testing a screen fluency of a terminal, comprising:
in response to receiving a test instruction, obtaining attribute information of the terminal and a test case, wherein the attribute information comprises a screen refresh rate;
controlling the test case to be displayed in the terminal according to a preset rule to obtain a number of frames generated by the terminal and a time period taken by the terminal to generate the frames; and
determining the screen fluency of the terminal based on the screen refresh rate, the number of frames and the time period.

2. The method according to claim 1, wherein the attribute information further comprises a screen size of the terminal, obtaining the test case comprises:
determining a data size of the test case according to the screen size of the terminal; and
selecting data matching the data size from a preset database to form the test case.

3. The method according to claim 1, wherein obtaining the number of frames generated by the terminal comprises:
determining the number of frames generated by the terminal according to a number of callbacks of a frame monitoring function in the terminal.

4. The method according to claim 1, wherein obtaining the time period taken by the terminal to generate the frames comprises:
determining the time period based on a time point when a frame monitoring function is called for the first time and a time point when the frame monitoring function is called for the last time.

5. The method according to claim 1, wherein controlling the test case to be displayed in the terminal according to a preset rule comprises:
controlling the test case to be displayed in the terminal in a sliding manner based on a preset order and/or speed.

6. The method according to claim 1, wherein determining the screen fluency of the terminal based on the screen refresh rate, the number of frames and the time period comprises:
determining a frame rate of the terminal based on the number of frames and the time period; and
determining the screen fluency of the terminal based on the frame rate and the screen refresh rate.

7. A device for testing a screen fluency of a terminal, comprising a non-transitory computer-readable medium comprising computer-executable instructions stored thereon, and an instruction execution system which is configured by the instructions to implement at least one of:
a first obtaining module, configured to obtain attribute information of the terminal and a test case in response to receiving a test instruction, wherein the attribute information comprises a screen refresh rate;
a second obtaining module, configured to control the test case to be displayed in the terminal according to a preset rule to obtain a number of frames generated by the terminal and a time period taken by the terminal to generate the frames; and
a determining module, configured to determine the screen fluency of the terminal based on the screen refresh rate, the number of frames and the time period.

8. The device according to claim 7, wherein the attribute information further comprises a screen size of the terminal, the first obtaining module comprises:
a first determining unit, configured to determine a data size of the test case according to the screen size of the terminal; and
a forming unit, configured to select data matching the data size from a preset database to form the test case.

9. The device according to claim 7, wherein the second obtaining module is configured to:
determine the number of frames generated by the terminal according to a number of callbacks of a frame monitoring function in the terminal.

10. The device according to claim 7, wherein the second obtaining module is configured to:
determine the time period based on a time point when a frame monitoring function is called for the first time and a time point when the frame monitoring function is called for the last time.

11. The device according to claim 7, wherein the second obtaining module is configured to:
control the test case to be displayed in the terminal in a sliding manner based on a preset order and/or speed.

12. The device according to claim 7, wherein the determining module comprises:
a second determining unit, configured to determine a frame rate of the terminal based on the number of frames and the time period; and
a third determining unit, configured to determine the screen fluency of the terminal based on the frame rate and the screen refresh rate.

13. A terminal device, comprising:
a memory, a processor and a touch screen, wherein,
the memory is configured to store an executable program code;
the touch screen is configured to display a test case;
the processor is configured to read the executable program code stored in the memory to execute a program corresponding to the executable program code, to implement a method for testing a screen fluency of a terminal, wherein the method comprises:
in response to receiving a test instruction, obtaining attribute information of the terminal and a test case, wherein the attribute information comprises a screen refresh rate;
controlling the test case to be displayed in the terminal according to a preset rule to obtain a number of frames generated by the terminal and a time period taken by the terminal to generate the frames; and
determining the screen fluency of the terminal based on the screen refresh rate, the number of frames and the time period.

14. The terminal device according to claim 13, wherein the attribute information further comprises a screen size of the terminal, obtaining the test case comprises:
determining a data size of the test case according to the screen size of the terminal; and
selecting data matching the data size from a preset database to form the test case.

15. The terminal device according to claim 13, wherein obtaining the number of frames generated by the terminal comprises:
determining the number of frames generated by the terminal according to a number of callbacks of a frame monitoring function in the terminal.

16. The terminal device according to claim 13, wherein obtaining the time period taken by the terminal to generate the frames comprises:
determining the time period based on a time point when a frame monitoring function is called for the first time and a time point when the frame monitoring function is called for the last time.

17. The terminal device according to claim 13, wherein controlling the test case to be displayed in the terminal according to a preset rule comprises:
controlling the test case to be displayed in the terminal in a sliding manner based on a preset order and/or speed.

18. The terminal device according to claim 13, wherein determining the screen fluency of the terminal based on the screen refresh rate, the number of frames and the time period comprises:
determining a frame rate of the terminal based on the number of frames and the time period; and
determining the screen fluency of the terminal based on the frame rate and the screen refresh rate.
